(19) United States
(12) Patent Application Publication
(10) Pub. No.: US 2012/0071131 A1
(43) Pub. Date: Mar. 22, 2012

(54) METHOD AND SYSTEM FOR PROFILING DATA COMMUNICATION ACTIVITY OF USERS OF MOBILE DEVICES

(75) Inventors: Roy ZISAPEL, Tel Aviv (IL); Amir PELES, Tel Aviv (IL); Avi CHESLA, Tel Aviv (IL)

(73) Assignee: RADWARE, LTD., Tel Aviv (IL)

(21) Appl. No.: 13/237,588

(22) Filed: Sep. 20, 2011

Related U.S. Application Data
(60) Provisional application No. 61/384,865, filed on Sep. 21, 2010.

(51) Int. Cl. H04W 12/00

(52) U.S. Cl. 455/410

(57) ABSTRACT

A method for profiling data communication activity of users of mobile devices, comprises sniffing traffic flows between a mobile device and the Internet through a cellular network; extracting a plurality of traffic attributes included in the traffic flows and associated with the mobile device; logging the extracted plurality of traffic attributes; analyzing the plurality of traffic attributes for generating a user profile for a user of the mobile device based on the plurality of traffic attributes, wherein the user profile includes at least one of an advertising targeted user profile and a security targeted user profile; and sharing information and alerts related to the generated user profile with at least one external system.

### CROSS-REFERENCE TO RELATED APPLICATIONS

This application claims the benefit of U.S. provisional application No. 61/384,865 filed on Sep. 21, 2010, the contents of which are incorporated herein by reference.

### TECHNICAL FIELD

This invention generally relates to profiling data communication activities including user browsing preferences and activities while utilizing a mobile network.

### BACKGROUND OF THE INVENTION

Targeting advertisements towards a specific demographic audience is a key in successful advertising. For example, TV commercials are frequently targeted towards a specific age and gender depending on the time of day the commercial is broadcast. The Internet has also become a popular medium for advertising, where commercials are included in web pages, for example, in a form of banners.

Many solutions have been developed for gleaning demographic information about Internet users in order for advertisers to target an audience/user that would be more interested in the advertised product. However, such solutions have failed to efficiently profile individual users who are browsing the Web.

One solution includes collecting statistics on individual users and the use of the advertisements displayed on single web site. For example, for each user, information about an IP address, a domain type, a time zone, a location of the user, and advertisements watched by users is gathered. By using such information, advertisements that a user with the same profile has expressed interest in can be determined and the user's preferences can be derived. Further, in order to allow the operation of such a solution an agreement between the advertiser and the operator of the web sites should be made. Thus, even if the user's identity is known, correlation can be made only with web sites for which there is an agreement in place.

As users cannot be uniquely identified, users' activities on other web sites cannot be cross correlated to build an accurate user profile. To resolve the identify issues, some solutions inject cookies and pixels (or other pieces of code) to identity the user on his computer. The injected identity is used whenever the user approaches any of the web sites that have an agreement with the advertiser. However, this is a non-transparent solution and as such, users typically either reject the insertion of cookies or frequently delete cookies and/or other types of tracking code from their computers.

As the popularity of mobile devices, such as smartphones, tablet computers, and the like (that allow browsing the Internet) rapidly increases, there is also an attempt in the industry to profile browsing preferences of users for the purpose of, for example, providing targeted advertisements to users of such devices. However, most solutions are based on the above-described techniques with or without combining with the mobile device location. The location is determined using a Global Positioning System (GPS) embedded in such devices or using coordinates provided by an operator of a cellular network. User identity of the smartphone owner can be correlated to the user's phone number and billing details. However, such information is not available outside of the wireless provider's network.

Some solutions use wireless provider data to determine a mobile user's web browser activity by capturing requests submitted by the users to a wireless provider portal, analyzing the requests, and then relating the request to the wireless network. However, such solutions cover only part of the smartphone user activity. In a typical wireless network environment, requests are directly transmitted from mobile devices through the wireless network. A request to a public internet web page is immediately directed to a web server residing in the Internet.

The high popularity of mobile devices invites malicious attacks. A mobile device includes an operating system (OS), such as Android®, iOS®, Windows®, and the like that allows the execution of applications (Apps) on the device. Hackers take advantage of the vulnerabilities of the operating system and applications executed thereon to commit malicious attacks.

Hackers aim to exploit these vulnerabilities in order to take control over mobile devices of the users in order to generate attacks against a third party website on their behalf and/or to direct the attack on the mobile devices. The attacks that can be committed by mobile devices or against mobile devices include, for example, a network denial-of-service (DoS) attack, an application DoS attack, network and application scanning, session hijacking (e.g., VoIP session hijacking, data sessions hijacking, and so on), a brute-force attack aimed at cracking user/password authentication mechanisms, and any other type of attack that can misuse the mobile network resources as well as servers executing application resources. The implications of such attacks may result in increased service latency, unusual battery draining behavior of the mobile machine, exposure of the user's confidential information, fraudulent activities, such as farming and phishing.

The advanced mobile devices allow connectivity to the Internet through a wireless local area network (WLAN) or a cellular network. While the WLAN is secured by the router and/or firewalls, the cellular network provides little protection, if any against malicious attacks. Commercial solutions that address security issues with respect for protection from attacks originated at the mobile devices through the cellular network, based on profiling of the behavior of users of such devices, have not been developed yet.

### SUMMARY OF THE INVENTION

Certain embodiments disclosed herein include a method for profiling data communication activity of users of mobile devices. The method comprises sniffing traffic flows between a mobile device and the Internet through a cellular network; extracting a plurality of traffic attributes included in the traffic flows and associated with the mobile device; logging the extracted plurality of traffic attributes; analyzing the plurality of traffic attributes for generating a user profile for a user of the mobile device based on the plurality of traffic attributes, wherein the user profile includes at least one of an advertising targeted user profile and a security targeted user profile; and sharing information and alerts related to the generated user profile with at least one external system.

Certain embodiments disclosed herein also include a system for profiling data communication activity of users of mobile devices. The system comprises a traffic logger for sniffing traffic flows between a mobile device and the Internet through a cellular network and extracting a plurality of traffic attributes included in the traffic flows and associated with the mobile device; an analyzer for analyzing the plurality of traffic attributes to generate a user profile for the user of the mobile device based, in part, on the plurality of traffic attributes, wherein the user profile includes at least one of an advertising targeted user profile and a security targeted user profile; a database for saving the generated user profile; and a profiling interface for interfacing with at least one external system for providing information and alerts related to the generated user profile.

Certain embodiments disclosed herein also include a method for targeting advertisement content to users of a mobile network. The method comprises sniffing traffic flows between a mobile device and the Internet through a cellular network; extracting a plurality of traffic attributes included in the traffic flows associated with the mobile device; logging the extracted plurality of traffic attributes; generating an advertising targeted user profile for a user of the mobile device based on the plurality of traffic attributes and at least one of demographic information, location information, and categorization information; and sharing the generated advertising targeted user profile with at least one of a publisher server and an advertiser server to provide at least advertisements that are of interest to the user.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is schematic diagram of a system utilized to describe certain embodiments of the invention;

FIG. 2 is a block diagram of a profiling system in accordance with an embodiment of the invention; and

FIG. 3 is a flowchart illustrating the operation of a profiling system in accordance with an embodiment of the invention.

### DETAILED DESCRIPTION OF THE INVENTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

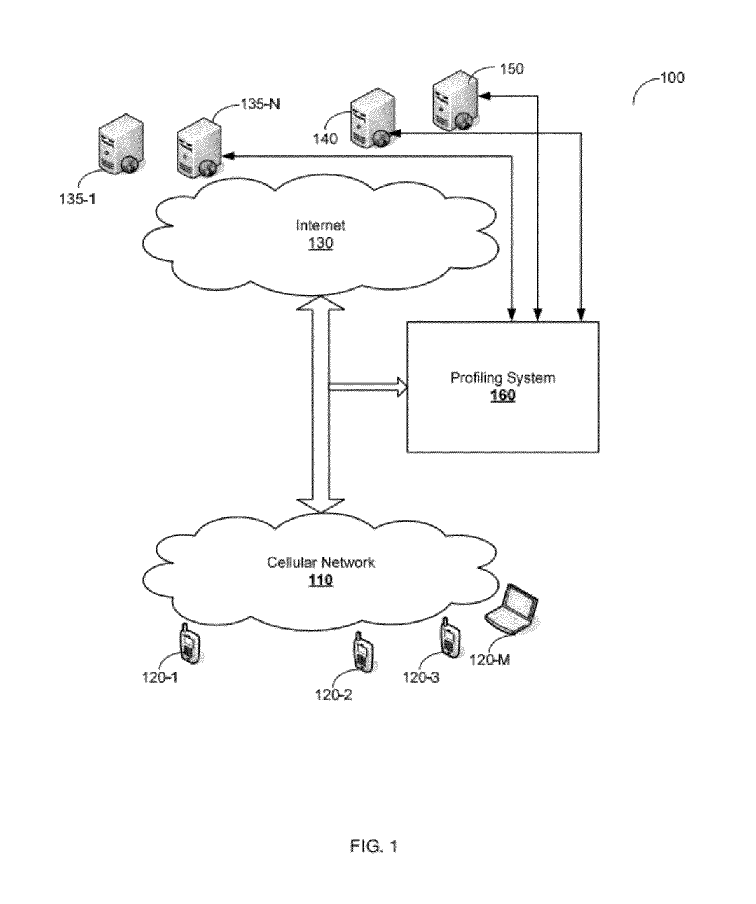

FIG. 1 shows a schematic diagram of a system 100 utilized to describe certain example embodiments of the invention. To a cellular network 110 there are connected a plurality of mobile devices 120-1 through 120-N (collectively referred to as mobile devices 120) (note that the term mobile devices does not imply that a mobile device must have mobility). The cellular network 110 may belong to a cellular service provider network based on, for example, GSM, CDMA, TDMA, communication protocols, 3G, LTE (also known as 4G), and the like. A mobile device 120 may include, but is not limited to, a laptop computer, a netbook computer, a tablet computer, a mobile phone, a smartphone, a personal digital assistant (PDA), or any computing device that can allow access to web pages. Requests for accessing web sites are sent from the cellular network 110 to a network 130. The network 130 may be, for example, a wide area network (WAN), that enables connectivity such as an Internet connectivity to a plurality of web servers 135-1 through 135-N (collectively referred to as web server 135) serving the mobile devices' 120 requests.

To the network 130 there is further connected a publisher server 140 which is capable of embedding online advertisements in web pages downloaded from web servers 135. The online advertisements are downloaded from one or more advertiser servers 150 belonging to one or more advertisement agencies. In addition, the online advertisements can be embedded in the web pages by the web servers 135. An online advertisement may be in a form of a banner, a video clip, an image, an audio clip, or combination thereof.

In accordance with certain embodiments of the invention, online advertisements embedded in a web page are targeted to a user requesting the page. With this aim, any of servers 135, 140, and 150 consult a profiling system 160 constructed in accordance with an embodiment of the invention.

The profiling system 160 generates an adaptive user profile for each user of a mobile device 120 by sniffing traffic flows between the cellular network 110 and the network 130. The traffic is analyzed and correlated with a plurality of attributes including, for example, a user's demographic data, a user's location, a web site's characteristics, and so on. In one embodiment of the invention, the generated profile is provided to any of servers 135, 140 and 150 to enable injecting online advertisements into web pages requested by a user's mobile device based on the user's profile. In another embodiment of the invention, the generated profile can be utilized to detect abnormal behavior of the mobile device 120 and to detect malicious attacks, such as those described above. The detection of potential attacks can be provided to security tools that can then block the attacks.

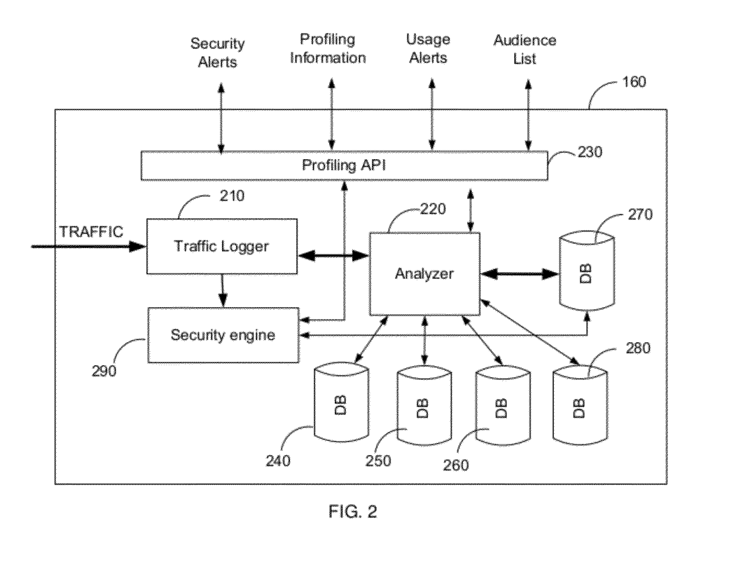

FIG. 2 shows an exemplary and non-limiting block diagram of the profiling system 160 that includes a traffic logger 210, an analyzer 220, a profile application-programming interface (API) 230, and a security engine 290. The traffic logger 210 is connected to one of the ports of the cellular network 110 (FIG. 1) and transparently sniffs traffic sent from or to each of the mobile devices 120 and logs traffic attributes of requests or responses. The collected information is saved per a source IP address of a mobile device 120, or any unique identifier of the device, such as a phone number.

The traffic attributes collected by the traffic logger 210 include, but are not limited to, an Internet protocol (IP) address of a mobile device 120, a destination address of a request, a destination URL, requested content and its type, request parameters, response parameters, reply data, keywords in search queries, keywords in request data, keywords in reply data, length of reply data, a response time of a mobile device 120, a response time of a web server 135, packet loss, retransmission rate, a number of open Layer 4 (IP) connections per second, a number of simultaneous Layer 4 (IP) connections, an average connection duration, a maximum connection duration, a number of transferred data bytes per a Layer 4 connection, a number of packets transferred per Layer 4 connection, distribution of destination IP addresses (e.g., 70% to destination IP address1; and 30% to IP address), distribution of destination port number (e.g., 80% to port 80, 20% to port 25), ratio of requests to replies in packets and bytes, error responses rates, distribution of Layer 4 (transmission) protocols (e.g., 60% UDP, 30% TCP, 10% others) and distribution of Layer 7 (application)protocols (e.g., 50% HTTP, 20% FTP, 10% SMTP), a number of transferred packets per second; and average size of data transferred per second, and so on.

A response is generated by each of web servers 135 responsive to a request sent by a mobile device. It should be appreciated that by transparently sniffing traffic flows, the traffic attributes can be logged and further processed without any need to use any tracking codes (e.g., cookies) or without using any device that relays requests from mobile devices 120 to the cellular network 110. In an embodiment of the invention, the traffic logger 210 may include a sniffer, a parser for parsing traffic and extracting the relevant attributes, and a database for storing the traffic attributes. The logger's database may be any tangible readable medium for storing digital data.

The profiling system 160 further includes a web categorization database (DB) 240 for storing categorization attributes, a user location database 250 for storing location attributes, a user account database 260 for maintaining the demographic attributes, and threats database 280 for storing characteristics of known attacks and attacks identified by the profiling system 160. Each of databases 240, 250, 260, 280 may be in any tangible readable medium for storing digital data.

The categorization attributes include mapping information of websites' URLs and keywords to one or more categories, such as shopping, news, sports, dating, and so on. For example, one entry in the database 240 may be <cnn.com, news> and a second entry may be <New York Yankees, sports>. The database 240 can be populated manually or automatically using, for example, a web crawler. The location attributes designate for each mobile device 120 its current location.

The location of the mobile device can be retrieved from the cellular provider using a GPS installed in the device. The location attributes saved in the database 250 may be in a form of coordinates and further can be mapped to a complete or partial address (state, city, neighborhood, and street).

The demographic attributes stored in the database 260 include, for each user of a mobile device 120, personal information as collected, in part, by the service provider. For example, without limitation, this information includes the user's phone number, name, mobile device type, mobile device activation number, age, gender, bills amount, payment history, and so on. The user account database 260 further maintains for each user the IP address (as collected by the logger 210) of its respective device. Since the IP address of a mobile user frequently changes in the user account database 260 when a mobile user connects, the data of a mobile user may relate to different IP addresses at different times.

The analyzer 220 analyses the traffic attributes in order to generate a user profile for a user of a mobile device 120. The analyzer 220 can generate different types of user profiles, a general, an advertising targeted, and a security targeted, each of which has its own purpose and may be selected by the operator of the cellular (mobile) network. The profiles are saved in a database 270. The general profile may include attributes related to the usage of the mobile device and practicality with regard to accessing the Internet.

The advertising targeted user profile is generated by correlating the logged traffic attributes together with at least one of the location, categorization, and demographic attributes to generate an adaptive profile for each user or group of users of each of the mobile devices 120. An advertising targeted user profile is an adaptive profile that describes the behavior and characteristics of the user's browsing activity that allows predicting advertisements that may be of interest to the user. It should be appreciated that because an IP address of a mobile device 120 can be associated with a user name and telephone number, the identity of a mobile device's user is known without having the user enter his/her personal information. Thus, any generated profile is of an actual user. In addition, there is no need to store data on the user mobile device. All the information is transparently received from the network.

An advertising targeted profile generated for a user, in accordance with an embodiment of the invention, contains one or more of the following characteristics: a category of interest, a short-term interest, a specific interest, an audience list, a browsing history, browsing patterns, and browsing experience. The profile can be updated over time as more information is collected. In addition, the profile may be adaptively changed at every new session that the mobile device establishes, at least to update the user location and IP address.

In order to generate the short-term interest as part of the advertising targeted user profile, the analyzer 220 correlates URLs requested by the user, during a predefined time interval, with the content of the web categorization database 240, and measures the access to websites that belong to a certain category. Category or categories that statistically show more activity from the user are utilized to determine the short-term interest. For example, if the user visited, during one week, one or more web pages that include mortgage information, such as, mortgage calculators, rates, and banks, then the user is tagged as having a short-term interest in mortgages. Identifying such interest can be performed by matching the web page URLs with entries in the database 240 of such websites that are categorized as “mortgage” or “financial services” Web sites. Another indication for a short-term interest can be derived by matching of specific keywords in the web requests and replies of the user with entries in the database 240 that map such keywords with categories of interest. For example, identifying that the user is searching the value “mortgage” in Google. The short-term interest would suggest a high value for displaying web pages on the user's mobile device that include advertisements related to purchasing of mortgages or other services related to purchasing a new home. The same logic can be applied to users who are identified as planning their coming vacation by browsing traveling web sites or hotel reservation web sites. It should be appreciated that a user can have multiple short-term interests and that change periodically.

The category of interest of the advertising targeted user profile is generated by correlating URLs that the user visited, over time, with the content of the categorization database 240 to detect one or more categories in which the user statistically shows interest. For example, the analyzer 220 can deduce that an actual user (e.g., a user identified by his name) is interested in news and sports by recognizing that the user approached news sites like “www.cnn.com” and sports' sections and sports sites like “www.nba.com”. The URLs as well as keywords are mapped in the categorization database 240 to interest categories. There may be logical rules that combine multiple URLs and keywords or monitor the number of times or a period in which a user approached a URL or used a keyword to update the user profile with a category of interest. A single keyword can point to multiple categories of interest. For example, the keyword “New York Yankees” can point to the categories “Sports”, “NY Yankees fans” and “New York” pending on the frequency of appearance of the keyword or correlation with other keywords.

The browsing history profile of a user is generated by analyzing the logged transactions of the user over a certain period of time. The history usually contains the log on each user transaction or an aggregated view of the transactions that would include the latest URLs/web sites visited by the user, the latest transactions of that user versus URLs/web sites belonging to a certain category, the latest transactions of the user from its current location and potentially other historical information from that user activity log. An example for such a profile is a history of travel searches (e.g., flights, hotels, and/or car rentals) is generated when the user accesses a news web site. Based on the browsing history profile, retrieved through the API 230, the news web site presents advertisements to the user on the travel destination of the user plans to travel to.

In order to determine the browsing patterns and browsing experience of a user, the analyzer 220 processes the traffic attributes in the traffic logger 210 to determine the average time each day that the user accesses the Internet with his/her mobile device, whether the user tends to perform online shopping from the mobile device, during which hours of the day the user accesses the internet, what type of content (e.g., video, image, text) the user prefers to view, and so on. The analyzer 220 can further determine the browsing experiences (or quality), for example, by processing any of error messages in responses sent to a mobile device 120 of a user, the packet loss rate, and the transmission rate of the traffic. Such an analysis may be used to apply a different service level agreement (SLA) guaranteed for users in relation to their browsing activity patterns, optimizing the experience for users during shopping activities or other activities that have higher value for the operator. The browsing patterns and browsing experience of a user can be part of the general profile.

In accordance with an embodiment of the invention, the analyzer 220 can cross correlate profiles of users to generate a list of users that may be a targeted audience for an advertising campaign. The list may show IP addresses, phone numbers, and identities of users having the same demographic attributes and/or location attributes, and some of their characteristics in common. For example, the targeted audience list may include a list of all teenage girls who live in New York City and show interest in an upcoming musical of their favorite pop star in the area. The targeted audience lists are saved in the database 270.

The security targeted user profile is an adaptive profile that describes the behavior and characteristics of the user's data communication activity that allows detecting potential attacks that are committed by the mobile device (i.e., originated at the mobile device) or targeted at the mobile device 120. As mentioned above, the profile can be generated without having the user enter his/her personal information. In an embodiment of the invention, the security targeted user profile is generated in response to a learning period through which the analyzer 220 analyses the logged traffic attributes in order to determine the behavior pattern of a user of a mobile device 120.

During the learning period the analyzer 220 waits unit sufficient amounts of traffic attributes are collected or after predefined time interval. Then, one or more statistical processes can be used to determine the normal activity behavior pattern of a user of a mobile device 120. The statistical processes may include, but are not limited to, linear averaging, exponential averaging, infinite impulse response (IIR) filters, and the like. Once the security targeted user profile is created the analyzer 220 dynamically updates the profile as new traffic attributes are logged. The updates may be continuous by applying moving window aggregation that groups data in recent history intervals through filtering average methods, such as IIR filters with different response coefficient options (e.g., 24 hours, a week, a month, etc.) or differential updates, i.e., grouping traffic attributes for aggregation according to hour and day in the week.

The security targeted user profile includes, without limitation, an average number of packets, an average data rate, a normal destination IP address distribution, a normal L4 port distribution, average connection duration, and a list of common access web sites accessed by the user, and so on.

The security engine 290 taps the traffic attributes collected by the traffic logger 210 and compares them to the security targeted profile saved in the database 270. Any deviation from the normal activity of the user (as indicated by the profile) is detected and an alert is asserted. Following are non-limiting examples for attacks that can be detected by the security engine: a DoS flood attack that is a deviation in the average number of packets and/or data rates; Network scanning which is a deviation from at least one of a normal destination IP address distribution, a Port distribution and a number of new connections per second; communication to drop points (e.g., server which is used as temporary storage for stolen confidential information of users') attack which can be typified by a deviation from the average connection duration, amount of data transmitted and destination IP distribution; and fraudulent activity which detects a deviation from a typical web sites category the user visits with a relativity high activity rate (such as connections per second, packet per second, etc.). The detected attacks are saved in the database 280 and can be shared with other security tools.

In an embodiment of the invention, the security engine 290 may be implemented not as part of the profiling system. In this embodiment, attacks can be detected, based on the security targeted profile, using detection engines, such as the adaptive fuzzy logic Inference systems, complex event processing (CEP) engines, and the like.

The profiling API 230 provides an interface for the web servers 135, 140, and 150 to retrieve a complete profile of one or more of the profile characteristics defined above and targeted audience lists. In accordance with an embodiment of the invention, a request to the API 230 to retrieve such information occurs when a user of a mobile device 120 browses to a website stored in one of web servers 135 or having advertised content managed by the publisher server 140 or advertiser server 150. Upon receiving a request for a URL of a web page, one of servers 135, 140 and 150 sends a request to receive the user profile (or its characteristics) associated with the mobile device 120 that requested the page. The request for a user profile may include an IP address of the mobile device. The profiling API 230 retrieves a profile or any of its characteristics of an actual user based on the received IP address. The API 230 does not expose the identity of the actual user associated with the IP address. The server analyzes the profiling information and inserts an online advertisement in the requested web page according to the user's interest. One skilled in the art would be familiar with the techniques for embedding online advertisement in web pages. Thereafter, the requested web page including the targeted online ad is sent to the user's mobile device 120.

In another embodiment one or more of servers 135, 140 and 150 may request profiling information of user, groups of users, or targeted audience lists to learn about the users' preferences in order for example, without limitation, to improve the content of web sites, to plan targeted campaigns, and so on. For example, an operator of a news web site may learn from the browsing patterns of users visiting different news web sites, that users prefer to view video clips rather than reading text articles.

In another embodiment, the publisher server 140 can set up a SMS advertising campaign towards a targeted audience. Accordingly, the server 140 requests the API 230 to identify the audience list for a certain campaign. As a result, the analyzer 220 identifies a list of users in the database 270 so that SMS messages can be sent to them. If such an audience list is not found in the database 270, the analyzer 220 cross correlates data from the databases 210, 240, 250, 260 to build the audience list.

In another embodiment, the publisher server 140 may request an alert upon identifying a user that fits a certain profile in the database 270. The analyzer 220 issues an alert to the publisher server 140 whenever a new user's activity (i.e., related traffic) matches a user to a profile or an audience list.

In another embodiment of the invention, the API profiling 230 sends alerts about potential attacks to an external system that can block or mitigate the attacks. An example for such a system includes, for example, a security information and event management (SIEM) device or engine or any other provisioning system that is integrated in the cellular network 110. In another embodiment of the invention, the alerts sent from the API 230 can activate an attack blocking mechanism. For example, the alert is provided to a network firewall which will block the malicious mobile device from accessing the network. Other mitigation action may include, for example, limiting the data rate of the malicious mobile device, disconnect any data services provided to the malicious mobile device, or redirect the user's requests to a website displaying a warning messages that specify which type of threat was identified and suggest a remediation course of action for the user.

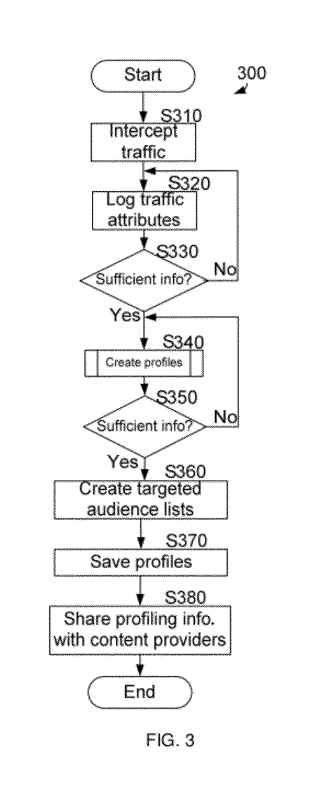

FIG. 3 shows an exemplary and non-limiting diagram of a flowchart 300 utilized to describe operation of the profiling system 160 in accordance with an embodiment of the invention. At S310, the traffic logger 210 sniffs traffic flows between the mobile devices 120 and the network 130. At S320, the traffic, i.e., requests and responses are processed in order to extract the traffic attributes included therein. For example, these attributes may be, without limitation, IP addresses of mobile devices, destination addresses and URLs, requested content and its type, requests' parameters, responses' parameters, keywords for search queries, keywords in request data, keywords in reply data, and so on. The traffic may be further processed to determine length of data sent by servers 135, a response time of servers 135, a response time of mobile device 120, a packet loss rate, a retransmission rate, and so on. Furthermore, for the purpose of generating the security targeted profile the traffic logger 120 can collect the following traffic attributes: a number of open Layer 4 (IP) connections per second, a number of simultaneous Layer 4 (IP) connections, an average connection duration, a maximum connection duration, a number of transferred data bytes per a Layer 4 connection, a number of packets transferred per layer 4 connection, distribution of destination IP addresses, distribution of Layer 4 destination ports, ratio of requests to replies in packets and bytes, error response rates, distribution of Layer 4 (IP) protocols and Layer 7 (application) protocols, a number of transferred packets per second; and average size of data transferred per second.

In accordance with an embodiment, the traffic attributes are associated with an IP address of a mobile device 120, hence with an actual user identified by his/her telephone number and name as appears in database 260 and its location as appears in database 250. Traffic attributes are stored in the logger 210.

At S330, it is checked if sufficient traffic attributes have been logged for a user, for example, if the number of logged attributes for a user meet a predefined threshold for performing user profiling of mobile device 120. If so, execution continues with S340; otherwise, execution returns to S310. It should be noted that the traffic logger 210 continues to gather traffic attributes as long as there is an active connection between a user's mobile device and the network 130 though the cellular network 110.

At S340, a profile for each user is generated by the analyzer 220. According to an embodiment of the invention, the analyzer 220 can generate, for each user, an advertising targeted user profile, a security targeted user profile, and a general profile application that combines these profiles. As described in detail above, to produce the advertising targeted traffic attributes are correlated with at least one of the demographic, location, and categorization attributes and uses statistical processing to determine at least one of the category of interest, short-term interest, audience list belonging, browsing history, browsing patterns, and browsing experience characteristics of a user. The demographic attributes are provided by the operator of the cellular network 110. The location attributes may include a static location or a dynamic location of a user. The categorization attributes include mapping of URLs and keywords to categories.

As mentioned earlier, the security targeted user profile defines the normal behavior of the user's browsing activity and is generated by statistically processing the collected traffic attributes.

At S350, a new profile of a user is cross correlated to identify multiple derivative user profile matches for the user. If so, execution continues with S360; otherwise, execution returns to S340. It should be noted that the analyzer 220 adaptively updates the created profile as new information is collected. Optionally, at S360, a targeted audience list that includes a list of IP addresses and identities of users is created. At S370, the profile and/or the targeted audience lists are saved in the database 270 and an instruction is sent to the profiling API 230 indicating that the profile of a certain user is ready for alerting. At S380, the profile API 230 may inform the content providers of servers 135, 140 and 150 that new profiling information is ready for a user.

In parallel, the API 230 may send of alerts on potential alerts as generated by a security engine based on the security targeted user profile. Furthermore, the profiling API 230 serves requests of content providers to retrieve at least one of a category of interest, a short-term interest, an audience list, a browsing history, a browsing patterns, and browsing experience characteristics created for users that accesses the network 130. The request from such content provider includes the IP address of the user. The system 160 uses the user account database 260 to identify the actual user that is currently associated with that IP address. Then, the profiling system 160 fetches the required user profile of that user and responds through the API 230. It should be emphasized that the information provided by the API 230 to the content provider does not include any illegal user identity, only the user's profile. It should be noted that the profile is associated with the identity of the user. Thus, even if the user accesses web sites using different IP addresses, the profile generated for the actual user is provided by the API 230. For example, a user “USER-1” accesses a web site using a user-IP1. The system 160 identifies the user-IP1 belonging to USER-1. The system logs USER-1 activity with a web site A that is categorized by Category X. Thereafter, USER-1 accesses a web site B using user-IP2. The system 160 identifies the user-IP2 belonging to USER-1 and logs the user activity with the web site B that is categorized by Category X. When the web site B uses the API to query on a user profile of the user-IP2, the profiling API 230 responds with the profile generated for USER-1 without exposing its identity. The foregoing detailed description has set forth a few of the many forms that the invention can take. It is intended that the foregoing detailed description be understood as an illustration of selected forms that the invention can take and not as a limitation to the definition of the invention.

Most preferably, the principles of the invention are implemented as any combination of hardware, firmware, and software. Moreover, the software is preferably implemented as an application program tangibly embodied on a program storage unit or non-transitory computer readable medium. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

What is claimed is:

1. A method for profiling data communication activity of users of mobile devices, comprising:
sniffing traffic flows between a mobile device and the Internet through a cellular network;
extracting a plurality of traffic attributes included in the traffic flows and associated with the mobile device;
logging the extracted plurality of traffic attributes;
analyzing the plurality of traffic attributes for generating a user profile for a user of the mobile device based on the plurality of traffic attributes, wherein the user profile includes at least one of an advertising targeted user profile and a security targeted user profile; and
sharing information and alerts related to the generated user profile with at least one external system.

2. The method of claim 1, wherein the plurality of traffic attributes include at least an Internet protocol (IP) address of the mobile device, a destination address of a request sent by the mobile device, a destination uniform resource locator (URL), a requested content and its type, keywords in submitted search queries, and keywords in request data.

3. The method of claim 2, wherein the plurality of traffic attributes further include at least one of: request parameters, response parameters, reply data, keywords in reply data, length of reply data, a response time of the mobile device, a response time of a web server receiving the request, a packet loss ratio, a retransmission rate, a number of open IP connections per second, a number of simultaneous IP connections, an average connection duration, a maximum connection duration, a number of transferred data bytes per an IP connection, a number of packets transferred per layer 4 connection, a distribution of destination IP addresses, distribution of destination port numbers, a ratio of requests to replies in packets and bytes, an error response rates, a distribution of transmission and application protocols, a number of transferred packets per second, and an average size of data transferred per second.

4. The method of claim 1, wherein generating the advertising targeted user profile further comprises:
correlating one or more of the plurality of traffic attributes with at least one of: demographic information, location information, and categorization information.

5. The method of claim 4, wherein the advertising targeted user profile describes the browsing activity of an actual user of the mobile device and allows predicting advertisements that are of interest to the user.

6. The method of claim 5, wherein an identity of the user is known by crossing the Internet protocol (IP) address of the user with at least a personal identifier of the mobile device.

7. The method of claim 5, wherein the advertising targeted user profile includes at least one of: a category of interest, a short-term interest, a specific interest, an audience list, a browsing history, browsing patterns, and a browsing experience.

8. The method of claim 7, wherein the short-term interest is generated by correlating URLs requested by the user during a predefined time interval with the web categorization information.

9. The method of claim 7, wherein the browsing history profile of a user is generated by analyzing logged transactions of the user over a predefined period of time.

10. The method of claim 7, wherein the browsing patterns are determined based on an average time that the user accesses the Internet through the mobile device, types of actions that the user performed while browsing, and a type of content that the user accessed.

11. The method of claim 7, wherein the browsing experience is generated by processing any error messages in responses sent to the mobile device of the user, a packet loss rate, and the transmission rate of the traffic.

12. The method of claim 7, wherein the audience list includes a list of user identities of users having at least the same short term interest.

13. The method of claim 5, further comprises sharing: the advertising targeted user profile with at least one of: a publisher server and an advertiser server.

14. The method of claim 13, wherein the sharing is in response to a request from the at least one of: the publisher server and the advertiser server.

15. The method of claim 3, wherein the security targeted user profile defines a normal baseline behavior of the data communication activity of a user of the mobile device.

16. The method of claim 15, wherein generating the security targeted user profile comprises statistically processing the plurality of traffic attributes during a learning period.

17. The method of claim 16, wherein the security targeted user profile defines at least: an average number of packets, an average data rate, a normal distribution of destination IP addresses, a normal distribution of destination port numbers, an average time of connection duration, and a list of commonly accessed web sites being accessed by the user.

18. The method of claim 15, further comprising:
comparing incoming traffic to the security targeted user profile to detect deviation from the security targeted user profile, wherein a deviation is an indication of a potential malicious attack.

19. The method of claim 18, wherein the malicious attack is at least one of: a network denial-of-service (DoS) attack, an application DoS attack, a network scanning, an application scanning, a session hijacking, a brute-force attack, an impersonator attack.

20. The method of claim 18, further comprising:
generating a security alert upon detection of a deviation from the security targeted user profile; and
sending the security alert to a blocking engine to block the potential attack, wherein the blocking engine is at least one of: a provisioning system of an operator of the cellular network or a network firewall.

21. A non-transitory computer readable medium having stored thereon instructions for causing one or more processing units to execute the method according to claim 1.

22. A method for targeting advertisement content to users of a mobile network, comprising:
sniffing traffic flows between a mobile device and the Internet through a cellular network;
extracting a plurality of traffic attributes included in the traffic flows associated with the mobile device;
logging the extracted plurality of traffic attributes;
generating an advertising targeted user profile for a user of the mobile device based on the plurality of traffic attributes and at least one of demographic information, location information, and categorization information; and
sharing the generated advertising targeted user profile with at least one of a publisher server and an advertiser server to provide at least advertisements that are of interest to the user.

23. The method of claim 22, wherein an identity of the user is known by crossing the Internet protocol (IP) address of the user with at least a personal identifier of the mobile device.

24. The method of claim 22, wherein the advertising targeted user profile includes at least one of: a category of interest, a short-term interest, a specific interest, an audience list, a browsing history, browsing patterns, and a browsing experience.

25. The method of claim 21, wherein the sharing is in response to a request from the at least one of: the publisher and the advertiser server.

26. A non-transitory computer readable medium having stored thereon instructions for causing one or more processing units to execute the method according to claim 21.

27. A system for profiling data communication activity of users of mobile devices, comprising:
a traffic logger for sniffing traffic flows between a mobile device and the Internet through a cellular network and extracting a plurality of traffic attributes included in the traffic flows and associated with the mobile device;
an analyzer for analyzing the plurality of traffic attributes to generate a user profile for the user of the mobile device based, in part, on the plurality of traffic attributes, wherein the user profile includes at least one of an advertising targeted user profile and a security targeted user profile;
a database for saving the generated user profile; and
a profiling interface for interfacing with at least one external system for providing information and alerts related to the generated user profile.

28. The system of claim 27, wherein the plurality of traffic attributes include at least an Internet protocol (IP) address of the mobile device, a destination address of a request sent by the mobile device, a destination uniform resource locator (URL), a requested content and its type, keywords submitted in search queries, keywords in request data,

29. The system of claim 28, wherein the plurality of traffic attributes further include at least one of: request parameters, response parameters, reply data, keywords in reply data, a length of reply data, a response time of the mobile device, a response time of a web server receiving the request, a packet loss ratio, a retransmission rate, a number of open IP connections per second, a number of simultaneous IP connections, an average connection duration, a maximum connection duration, a number of transferred data bytes per an IP connection, a number of packets transferred per layer 4 connection, a distribution of destination IP addresses, a distribution of destination port numbers, a ratio of requests to replies in packets and bytes, an error response rate, a distribution of transmission and application protocols, a number of transferred packets per second, and an average size of data transferred per second.

30. The system of claim 27, wherein the analyzer is configured to generate the advertising targeted user profile by correlating one or more of the plurality of traffic attributes with the least one of demographic information, location information, and categorization information.

31. The system of claim 27, wherein the advertising targeted user profile describes the browsing activity of an actual user of the mobile device and allows predicting advertisements that are of interest to the user.

32. The system of claim 27, wherein an identity of the user is known by crossing the internet protocol (IP) address of the user with at least a personal identifier of the mobile device.

33. The system of claim 30, wherein the advertising targeted user profile includes at least one of: a category of interest, a short-term interest, a specific interest, an audience list, a browsing history, browsing patterns, and a browsing experience.

34. The system of claim 33, wherein the analyzer is configured to generate the short-term interest by correlating URLs requested by the user during a predefined time interval with the web categorization information.

35. The system of claim 33, wherein the analyzer is configured to generate the browsing history profile of the user by analyzing logged transactions of the user over a predefined period of time.

36. The system of claim 33, wherein the analyzer is configured to determine the browsing patterns based on an average time that the user accesses the Internet through the mobile device, types of actions that the user performed while browsing, and a type of content that the user accessed.

37. The system of claim 33, wherein the analyzer is configured to determine the browsing experience by processing error messages included in responses sent to the mobile device of the user, a packet loss rate, and the transmission rate of the traffic.

38. The system of claim 33, wherein the audience list includes a list of user identities of users having at least the same short term interest.

39. The system of claim 33, wherein the profiling interface is configured to share at least one of the advertising targeted user profile, usage alerts, and an audience list with at least one of: a publisher server and an advertiser server.

40. The system of claim 39, wherein the sharing is in response to a request from the at least one of: the publisher server and the advertiser server.

41. The system of claim 28, wherein the security targeted user profile defines a normal baseline behavior of the browsing activity of a user of the mobile device.

42. The system of claim 41, wherein the analyzer is configured to generate the security targeted user profile by statistically processing the plurality of traffic attributes during a learning period.

43. The system of claim 41, wherein the security targeted user profile defines at least one of: an average number of packets, an average data rate, a normal distribution of destination IP addresses, a normal distribution of IP port numbers, an average time of connection duration, and a list of commonly accessed web sites being accessed by the user.

44. The system of claim 41, further comprising:
a security engine for comparing incoming traffic flows to the security targeted user profile to detect a deviation from the security targeted user profile, wherein the deviation is an indication for a potential malicious attack; and
generating a security alert upon detection of a deviation from the security targeted user profile.

45. The system of claim 44, wherein the malicious attack includes at least one of: a network denial-of-service (DoS) attack, an application DoS attack, a network scanning, an application scanning, a session hijacking, a brute-force attack, an impersonator attack.

46. The system of claim 44, wherein the profiling interface is further configured to
send the security alert to a blocking engine to block the potential attack, wherein the blocking engine is at least one of: a provisioning system of an operator of the cellular network and a network firewall.

47. The system of claim 27, wherein the cellular network is at least one of: GSM, CDMA, TDMA, 3G, and LTE, and combination thereof.
